(19) United States
(12) Patent Application Publication
(10) Pub. No.: US 2007/0003272 A1
(43) Pub. Date: Jan. 4, 2007

(54) Lenticular photography

(76) Inventor: Jeffrey Robb, Surrey (GB)

Correspondence Address: WALLENSTEIN & WAGNER, LTD., 311 SOUTH WACKER DRIVE, 53RD FLOOR, CHICAGO, IL, 60606, US

(21) Appl. No.: 11/352,433

(22) Filed: Feb. 10, 2006

(30) Foreign Application Priority Data
Jul. 1, 2005 (GB) GB 0513475.4

(51) Int. Cl. G03B 41/00

(52) U.S. Cl. 396/333

(57) ABSTRACT

A lenticular photograph comprises a lenticular lens sheet having upper and lower substrates, the latter defining a series of elongate lenses. The upper and lower surfaces of the lens sheet are planar, and are suitable for lithographic printing. A composite interlaced image is printed onto the lower surface, for viewing through the sheet. Additional printing may also be provided on the upper surface. Individual lenticular photographs may be created using an integrated system that takes multiple photographs of a subject and prints a composite image onto the lower surface of a lens sheet as described.

The present invention relates to lenticular photography.

Lenticular photography systems typically make use of a lenticular lens sheet which is an array of identical elongate lenticular lenses, or lenticules, usually elongate convex lenses on an upper display surface of the sheet. The sheet normally has a planar lower surface. A lenticular photograph, for example a lenticular representation of a stereoscopic image, (eg a three dimensional image or an animation) is formed when a suitably-produced composite interlaced image is printed or secured to the lower surface so as to be viewable through the sheet. The composite comprises elongate strips of images which are appropriately interlaced and dimensioned so as to be aligned with the overlying lenses. The specific characteristics of the lenticular photograph/product are determined by the particular dimensions, shape and design of the convex lenses and the composite interlaced image.

An appropriately-composed interlaced image located under a suitably constructed lenticular lens sheet enables a viewer to perceive various effects such as binocular disparity, whereby each of the viewer's eyes, having different viewing angles to the sheet, sees a different elongate stripe. Binocular disparity is an effect that is used in lenticular products for displaying images which are perceived by a viewer as three dimensional images. Alternatively, the interlaced strips of image and lenticular lens sheet can be arranged so that a viewer, when viewing the sheet from a certain angle, sees the same set of strips from each eye, the viewable strips forming an image. When the viewer views the lens from a different angle, a different set of strips is seen, forming a different perceived image. Thus the image which is perceived by the viewer changes in dependence upon the viewing angle. Such an effect may be used for displaying short animations.

Lenticular printing to produce animated or three dimensional effects as a mass reproduction technique started as long ago as the 1940s. The most common method of lenticular printing, which accounts for the vast majority of lenticular images in the world today, is lithographic printing of the composite interlaced image directly onto lower surface of the lenticular lens sheet.

A typical lenticular photograph, as well known in the art, is shown in a cross sectional view in FIG. 1. The photograph consists of a lenticular lens sheet 100 manufactured from a transparent medium 110 which has a planar lower surface 150 and an upper surface comprising a longitudinal array of elongate protrusions 120 and recessions 130. The elongate protrusions 120 and recessions 130 form lenticular lenses on the upper surface of the sheet. A composite interlaced image 140 is suitably aligned with the lenticular lens sheet and printed directly onto the lower planar surface of the transparent medium such that the lenticular lenses focus incident light onto elongate stripes of the image, enabling a viewer to view the differing elongate stripes in dependence upon viewing angle.

Other types of lenticular lens sheet, typically made from glass substrates, are also known for use in an entirely different field, namely for projectors, screens and overhead displays. Here, the aim is normally to increase the illumination of a display, or its available viewing angle. Examples of sheets for use in such applications are illustrated in the following Japanese publications: JP10039420, JP2000231008, JP8171003 and JP9292502.

According to a first aspect of the invention there is provided a lenticular photograph comprising:
a lens sheet having planar upper and lower surfaces, the lens sheet comprising a lower substrate having an upper substrate surface defining a plurality of elongate lenses, and an upper substrate overlying the lower substrate, the upper substrate having a refractive index which differs from that of the lower substrate; and
an interlaced composite image, located beneath the lower substrate, and viewable through the lens sheet.

According to a further aspect there is provided an integrated system for image capture, image processing and image printing for the creation of an individual lenticular photograph of a subject, the system comprising:
an imager arranged to acquire multiple images of the subject,
an image processor for creating a composite interlaced image of said multiple images;
a lens sheet having planar upper and lower surfaces, the lens sheet comprising a lower substrate having an upper substrate surface defining a plurality of elongate lenses, and an upper substrate overlying the lower substrate, the upper substrate having a refractive index which differs from that of the lower substrate; and
a printer for printing said composite interlaced image onto said lower surface of said lens sheet.

A lenticular lens sheet according to some embodiments of the present invention comprises a substrate made from a first transparent medium with a planar lower surface and an array of longitudinally arranged elongate protrusions and recessions on its upper surface forming lenticular lenses. A second transparent medium, made from a material with a different refractive index to the substrate, with a planar upper surface forms an upper layer atop the substrate.

The upper layer provides a planar upper surface to the lenticular lens sheet which reduces glare whilst still enabling the lenticular lenses to function efficiently, i.e. it is still able to focus incident light onto interlaced elongate strips of images located below the lenticular lens sheet. Furthermore, the upper layer provides a protective layer above the substrate. Printing on the upper surface of the lenticular lens sheet is also greatly facilitated due to the surface being planar. Additionally, a planar upper surface is more aesthetically pleasing to a viewer than the corrugated upper surface texture typically used with previous lenticular photographic products. The aesthetics of lenticular products is important since they are often used for novelty items, branding, advertising and merchandising.

The lens sheet, which may be printed on either or both sides, may be flexible or may alternatively be rigid.

In a further embodiment of the invention, the upper layer comprises a planar upper surface and a lower surface with recessions and protrusions reciprocal to protrusions and recessions on the upper surface of the substrate, the upper layer being formed independently of the substrate.

In yet a further embodiment, the upper layer is formed directly onto the substrate by a coating of the second transparent medium which infills the protrusions and recessions on the upper surface of the substrate producing a planar upper surface of the lenticular lens sheet.

Embodiments according to the present invention are preferably used in conjunction with a composite of interlaced elongate stripes of composite images disposed beneath the lenticular lens sheet. A composite interlaced image can be provided by a sheet with the composite interlaced image printed thereon, a display screen, such as an LCD display, with the composite interlaced image displayed thereon or —most preferably—by printing, such as lithographic printing, of the composite interlaced image directly onto the lower surface of the lenticular lens sheet. In each case the composite interlaced image should be suitably and accurately aligned with the lenticular lens sheet such that the lenticular lenses focus incident light onto certain elongate stripes enabling a viewer to view the certain elongate stripes in dependence upon viewing angle.

Lenticular lens sheets can be used for any type of lenticular image, for example representing a steroscopic three dimensional image, an animation or a selection of different images or displayed information.

The present invention may be carried into practice in a number of ways, and several specific embodiments will now be described, by way of example, with reference to the accompanying drawings, in which:

FIG. 1, is a cross-sectional view of a typical lenticular photograph as known in the art;

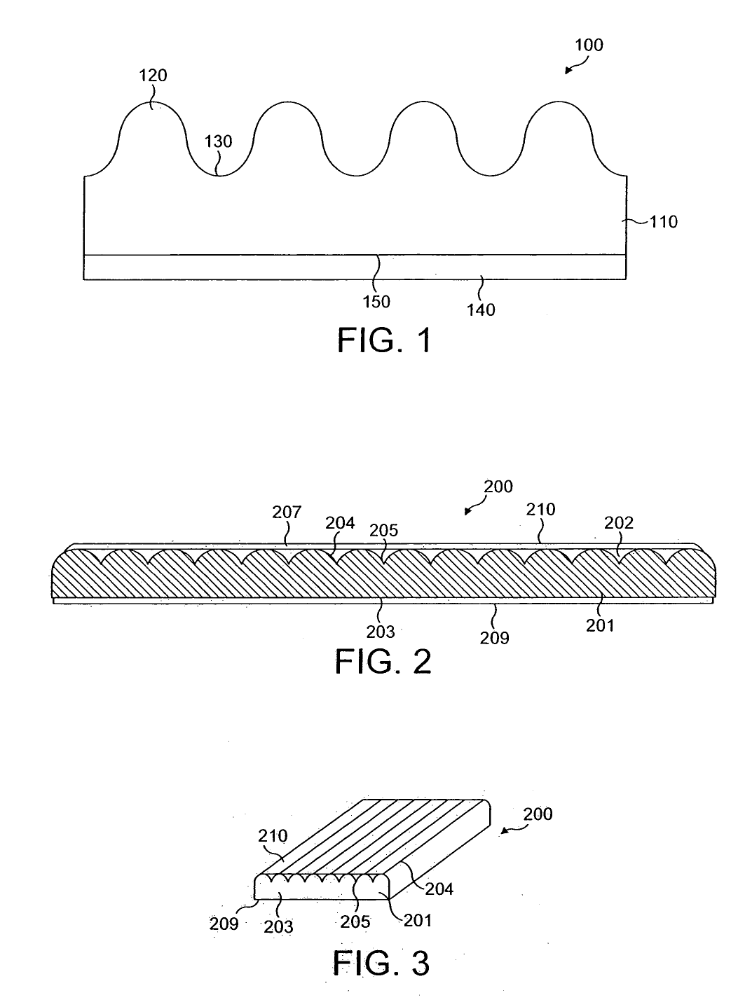

FIG. 2, is a cross-sectional view of a lenticular photograph according to a first embodiment of the present invention;

FIG. 3, is the perspective view of the lenticular photograph of FIG. 1;

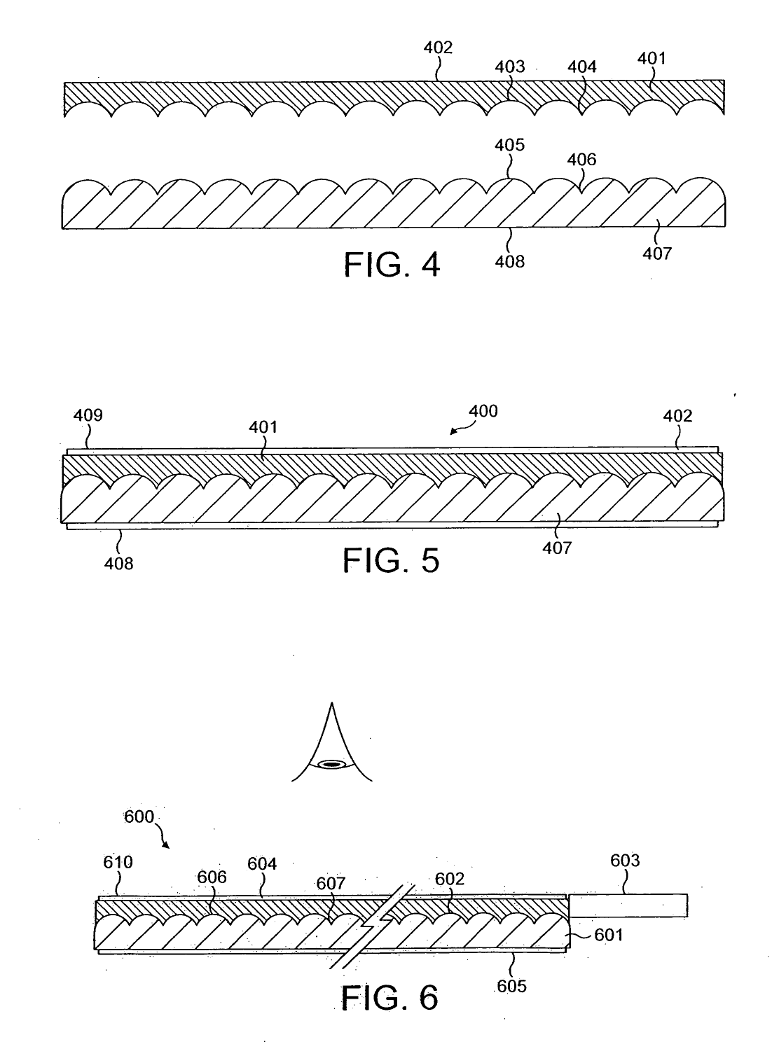

FIG. 4 is a cross-sectional view of a the composite parts of a lenticular photograph according to a second embodiment of the present invention;

FIG. 5 is a cross-sectional view of the lenticular photograph according to the second embodiment of the present invention, as assembled;

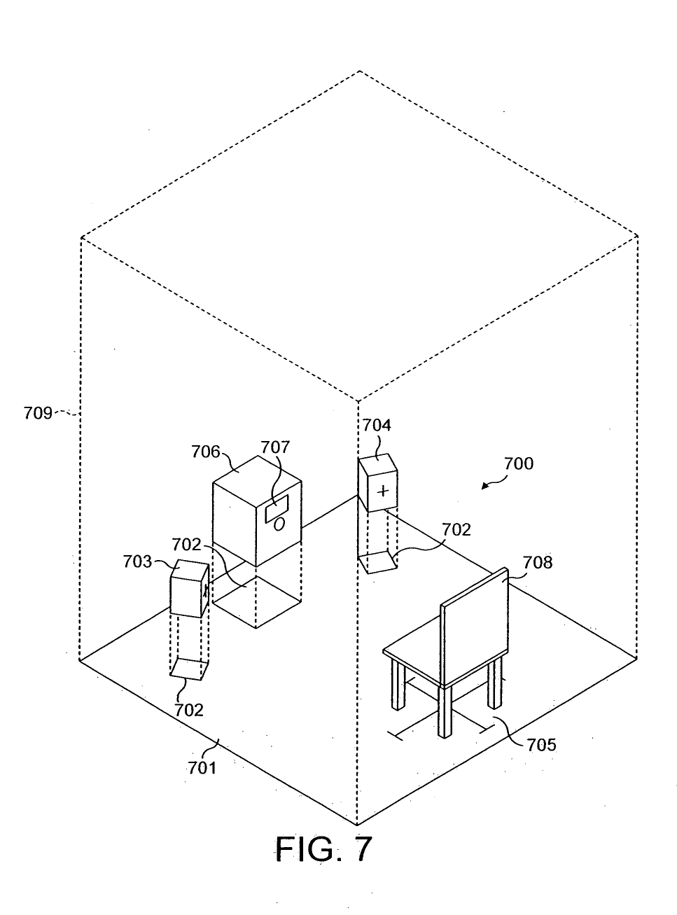

FIG. 6 is a cross-sectional of a lenticular photograph according to a third embodiment of the present invention; and

FIG. 7 is a schematic diagram of a system for imaging, processing and printing lenticular products, according to a further embodiment of the invention.

As shown in FIGS. 2 and 3, a lenticular photograph 200 according to a first embodiment of the present invention includes a substrate 201 and an upper layer 202 together defining a lenticular lens sheet. The substrate 201 and upper layer 202 are made from transparent materials of differing refractive indices. The substrate 201 has a planar lower surface 203 and an array of longitudinally-aligned prisms or elongate protrusions 204 and recessions 205 on an upper surface, forming lenticules or lenticular lenses. Preferably, the elongate protrusions and recessions are parallel to one another.

Typically, the elongate protrusions 204 recessions 205 are in the cross-sectional shape of juxtaposed semicircles forming an array of convex lenses. However, the protrusions and recessions could alternatively be in a cross-sectional form of juxtaposed waves, saw tooth functions, top hat functions or the frustra of polygons.

The substrate 201 may be made of a polymer such as glycol modified polyethylene terephthalate (PETG), and may be produced through injection moulding or alternatively by flat sheet extrusion If particularly high quality lenses are required, the substrate 201 can be made by casting. However, the preferred method of manufacture of the substrate is embossing of a flat plastics material sheet under heat and pressure using an engraved metal cylinder.

The upper layer 202 is made from a transparent medium, preferably a polymer such as fluorinated ethylene propylene, which has a refractive index which is lower, preferably substantially lower, than that of the substrate 201. Alternatively, the refractive index of the upper layer could be higher than that of the lower. Preferred methods of coating the substrate with the polymer include physical vapour deposition (PVD) or some other type of sputter coating, either by direct deposition or reactively. Curtain-coating, where a stream of molten liquid is poured down onto the substrate could also be used. Coating could also be by screen printing or roll coating. Further possibilities include laminating, casting or injection moulding

The lenticular lens sheet, being planar on both its upper and lower surfaces is particularly suitable for printing, and especially for lithographic printing. As shown schematically in FIGS. 2 and 3, the lower surface carries a printed ink layer 209, defining the interlaced image; while the upper surface, or a part thereof, may carry an additional overprinted ink layer 210. The Overprinting could carry additional image features, associated with or distinct from the main image, or alternatively could carry text. The overprinted layer could also include coloured areas and/or coloured filters through which parts of the underlying image are visible.

In an alternative embodiment, shown in FIG. 4 and 5, the substrate 407 and upper layer 401 are independently formed and are brought together to form a composite lenticular lens sheet 400 (FIG. 5). The upper layer 401 is formed from a material of a differing (preferably lower) reflective index from that of the substrate and is glue-fitted to the substrate 407 to form a continuous structure 400 whose upper surface 402 and lower surface 408 are both planar.

The upper layer 401 has a planar top surface 402 and an array of longitudinally-aligned elongate recessions 403 and protrusions 404 along its lower surface. The elongate recessions 403 and protrusions 404 are reciprocal to the elongate protrusions 405 and recessions 406 on an upper surface of the substrate 407.

Once the upper layer and the substrate have been aligned and secured together, as shown in FIG. 5, lithographic or other printing technologies may be used to apply a lower ink layer 408 defining the interlaced image, and an optional upper ink layer 409, as described above.

FIG. 6, shows another embodiment similar to that of FIG. 5. A lenticular lens sheet or lenticular screen 600 is formed by a transparent overlay material covering layer 602 used to infill a lenticular overlay or lenticular lens 601 across its exposed upper surface 606 so that an outer surface 604 of the lenticular lens sheet forms an outer flat layer which removes the effect of contours 607. This produces a smooth outer surface 604 enabling the surface to be more readily printable. The lenticular lens sheet 600 is overlaid on a printed composite interlaced image 605. The composite interlaced image sits in, and is supported by, an integral frame 603. Alternatively, the image may be printed directly onto the lower surface of the lens 601. The upper surface of the covering layer 602 may be overprinted with a further ink layer 610.

The lenticular lens 601 is formed by injection moulding which ensures the registration and correct alignment of the composite interlaced image 605 with the lenticular lens is achieved. It will be understood that the lenticular lens sheet 600 may be used in conjunction with a display device (not shown), such as a liquid crystal screen that displays moving images.

The lens 601 may be injection moulded as a one-step process and the frame 603 integrated into a mould to form a single piece lens 601 cover 602 and frame 603 product. Additionally, because the lens can be injection moulded, each lens piece is identical. This means printing in register and correct alignment is solved is because once set, the printer will always be located at precisely the correct position.

FIG. 7 shows a schematic overview of an integrated system 700 that is arranged to obtain an electronic image and to produce a hard copy print-out of a lenticular photograph ‘on the fly’ or in a semi-instantaneous process, for example producing a stereogram or animation on a lenticular lens sheet such as those shown in FIGS. 2 to 6 and described above.

The system 700 is modular and portable, for example in suitably lined steel or stainless steel carrying cases (not shown). The cases, once unpacked, act as seats, stands and supports for the various elements described below. This system enables the equipment to be packed, stowed and transported for example in a trunk/boot of an automobile and rapidly deployed at its intended location. Alternatively, the system can be located in a housing 709 such that the system is arranged as a self-contained booth or photo kiosk.

The system 700 includes a flexible rubber mat 701 on which indicator lines or patterns 702 are painted. The indicator lines are arranged so that illumination sources 703 and 704 can be suitably oriented onto a target area 705. The target area 705 on the mat indicates the position of a subject whose image is to be taken. Imaging equipment, processing means and printing equipment are all preferably housed in a housing 706. The mat 701 may be easily rolled up for storage or transport.

Illumination means, ballast and power supply, are supplied in a suitable tower or stand (not shown). The illumination means provide the necessary “flat” lighting conditions which are required by professional photographers and usually found in photographic studios.

Housing 706 ideally includes a liquid crystal screen 707, focusing and other equipment arranged to assist an operator in obtaining an image of the subject sat on chair 708, typically at a distance of 1 to 3 metres from the imaging equipment.

As the subject is able to view a preview of the file image on the screen 707 it is possible for the subject to adjust his or her pose in anticipation of an image being taken. The screen then provides a preview of the image and once selected a hard copy of the lenticular product can be can be created.

A touch screen (not shown) is located so that the operator can select various options. This ensures that specific quality standards are met as well as enabling the system to be used by inexperienced personnel.

1. A lenticular photograph comprising:
a lens sheet having planar upper and lower surfaces, the lens sheet comprising a lower substrate having an upper substrate surface defining a plurality of elongate lenses, and an upper substrate overlying the lower substrate, the upper substrate having a refractive index which differs from that of the lower substrate; and
an interlaced composite image, located beneath the lower substrate, and viewable through the lens sheet.

2. A lenticular photograph as claimed in claim 1 in which the image is printed on the lower surface of the lens sheet.

3. A lenticular photograph as claimed in claim 2 in which the image is lithographically printed.

4. A lenticular photograph as claimed in claim 1 in which the upper surface or a part thereof carries a further printed image or coating.

5. A lenticular photograph as claimed in claim 4 in which the further image or coating is lithographically printed.

6. A lenticular photograph as claimed in claim 1 in which the upper substrate comprises a polymer

7. A lenticular photograph as claimed in claim 6 in which the polymer is a fluorinated ethylene propylene.

8. A lenticular photograph as claimed in claim 1 in which the lower substrate comprises a polymer.

9. A lenticular photograph as claimed in claim 8 in which the polymer is a glycol modified polyethylene terephthalate.

10. A lenticular photograph as claimed in claim 1 in which the lens sheet is flexible to facilitate lithographic printing on the upper and lower surfaces.

11. An integrated system for image capture, image processing and image printing for the creation of an individual lenticular photograph of a subject, the system comprising:
an imager arranged to acquire multiple images of the subject,
an image processor for creating a composite interlaced image of said multiple images;
a lens sheet having planar upper and lower surfaces, the lens sheet comprising a lower substrate having an upper substrate surface defining a plurality of elongate lenses, and an upper substrate overlying the lower substrate, the upper substrate having a refractive index which differs from that of the lower substrate; and
a printer for printing said composite interlaced image onto said lower surface of said lens sheet.

12. An integrated system as claimed in claim 11 in which the printer further prints onto the upper surface of the lens sheet.
